(19) United States
(12) Patent Application Publication
(10) Pub. No.: US 2011/0188349 A1
(43) Pub. Date: Aug. 4, 2011

(54) System and Method of Determining an Underwater Location

(76) Inventor: Rita A. Basilico, Raleigh, NC (US)

(21) Appl. No.: 12/699,405

(22) Filed: Feb. 3, 2010

(51) Int. Cl. G01S 3/80

(52) U.S. Cl. 367/118

(57) ABSTRACT

An underwater device receives underwater signals from a pair of beacon units. Based on these signals, a processing circuit in the device determines a distance and a direction to each beacon unit. The underwater device also measures a depth for the device, and an angle of arrival of one or both of the incoming signals. Based on the distances to the two beacon units, the depth of the device, and the measured angle of arrival, the processing circuit can determine a current underwater location for the device.

### BACKGROUND

The present invention relates generally to underwater navigational aids and, more particularly, to a method and apparatus for computing the location of an underwater target.

Satellite-based positioning systems, such as the Global Positioning System (GPS), provide the ability to accurately determine location virtually almost anywhere on the Earth's surface. The GPS comprises 24 earth-orbiting satellites located in 6 orbital planes. Each earth-orbiting satellite carries an atomic clock and continuously broadcasts radio signals indicating its current time and location. A receiver located on the Earth's surface can receive these radio signals and determine its distance from the satellites based on the time of arrival of the signals. By receiving signals from four satellites, an Earth-based receiver can triangulate its location (i.e., its latitude, longitude, and altitude) on the Earth's surface.

However, GPS signals do not propagate underwater. Consequently, divers and underwater vehicles beneath the water's surface are not able utilize GPS signals to accurately determine their current location, or to navigate to a location. A number of systems have been proposed to extend GPS to underwater divers and vehicles. However, these systems are complicated and not widely available. Further, prior art solutions require at least three units to provide the signals needed for a diver or vessel to triangulate their location. Such systems are not practical for a diver or other vessel that can only receive location signals from two or fewer units.

### SUMMARY

The present invention provides a navigation device that allows underwater divers to determine their position without having to surface, and by using a fewer number of known reference points than do conventional devices. In one embodiment, a diver wears an underwater navigation device on his wrist. The device has a communication interface to receive signals transmitted by first and second underwater beacon units, a depth sensor to determine the diver's depth underwater, and a processor to compute the diver's location based on this information.

In one embodiment, the underwater device receives signals from the first and second beacon units. Based on these signals, the processor determines a first distance and direction to the first beacon unit, and a second distance and direction to the second beacon unit. The processor then determines the depth of the diver based on the output of the depth sensor. The processor then uses this information and known mathematical techniques to calculate the angle of arrival of one or both of the received signals at the underwater device. From this data, the processor computes the current location of the underwater device.

### BRIEF DESCRIPTION OF THE DRAWINGS

FIG. 1 is a block diagram illustrating an exemplary communication system suitable for use in one embodiment of the present invention.

FIG. 2 is a perspective view illustrating a navigational device worn by an underwater diver. The device in FIG. 2 is configured to determine the diver's underwater position according to one embodiment of the present invention.

FIG. 3 is a block diagram illustrating some of the component elements of a navigational device configured according to one embodiment of the present invention.

FIG. 4 is a flow diagram illustrating a method performed by a navigational device according to one embodiment of the present invention.

FIG. 5 illustrates the underwater position of a diver as determined by a navigational device configured to determine that location according to one embodiment of the present invention.

FIG. 6 illustrates how the underwater navigational device computes the direction to a beacon unit, as well as the angle of arrival of a signal transmitted by the beacon unit, according to one embodiment of the present invention.

### DETAILED DESCRIPTION

The present invention provides an apparatus and method for determining the underwater position of a device using the known locations of only two beacon units rather than three or more beacon units as required by conventional methods. More particularly, a device configured to function according to the present invention receives underwater signals transmitted by a pair of beacon units. Based on these signals, the device computes a distance and direction to each beacon unit, and computes an angle of arrival for one or both of the signals transmitted by the beacon units. The device also determines its own depth. Based on these factors, the device can compute its current position underwater.

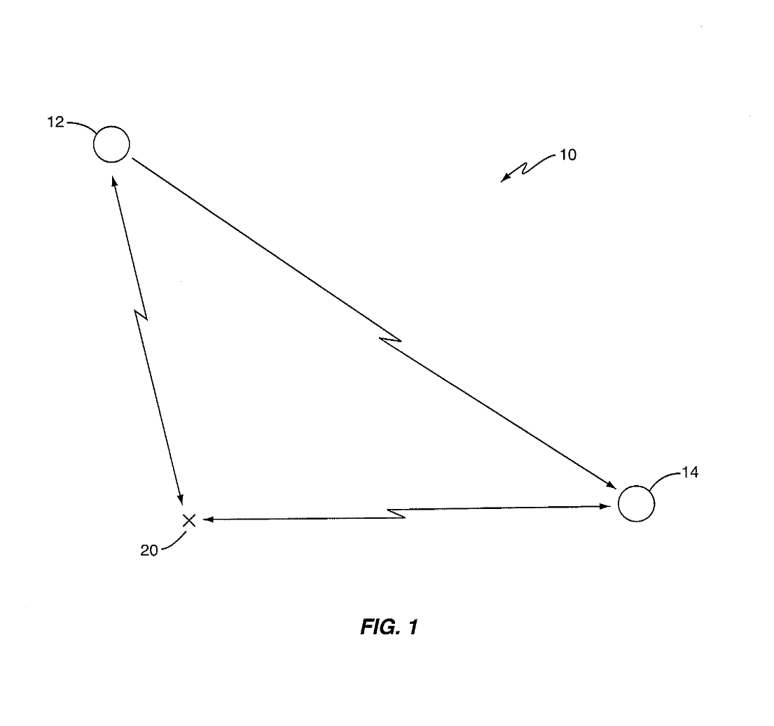

Referring now to the drawings, FIG. 1 illustrates a communication system 10 comprising a pair of beacon units 12, 14, and a diver unit 20. The beacon units 12, 14 are used primarily as markers and can provide navigation assistance to the diver unit 20 as hereinafter described. Beacon units 12, 14 are geographically separated and may be located on or near the surface a body of water, such as an ocean or sea, for example, or underwater on or near the sea floor. In operation, beacon units 12, 14 transmit underwater signals for receipt by the diver unit 20. Based on these two signals, the diver unit 20 can determine the current 3-dimensional position of the diver unit 16.

The beacon units 12, 14 may be any unit capable of transmitting an signal that propagates under for reception by diver unit 20. For example, in one embodiment of the present invention, the beacon units 12, 14 comprise beacon units disclosed in U.S. Pat. No. 7,272,074. The '074 patent, which is entitled “System and Method for Extending GPS to Divers and Underwater Vehicles,” was filed on Jul. 15, 2005, and is incorporated herein by reference in its entirety. The '074 discloses the structural and functional aspects of some exemplary beacon units in detail; however, a brief discussion is included herein for clarity.

The beacon units in the '074 patent are deployed as underwater navigation aids. Particularly, the beacon units are deployed in a body of water, such as the ocean, along with one or more surface units. The surface units remain on the surface while the beacon units sink to the floor of the body of water. While floating, the surface units receive Global Positioning and Satellite (GPS) signals from the GPS satellites and uses the received GPS signals to determine their locations. After the beacon units come to rest, one or more of the surface units transmit their respective locations to each of the beacon units. The beacon units can then determine their own locations based on the signals received from the one or more surface units. In some embodiments, the beacon units may determine their location based on signals received from a single surface unit. In other embodiments, the beacon units may receive signals from multiple surface units. The beacon units may also exchange information between themselves to further refine their position calculations. After the beacon units determine their location, the beacon units can provide navigation assistance to diver units 20.

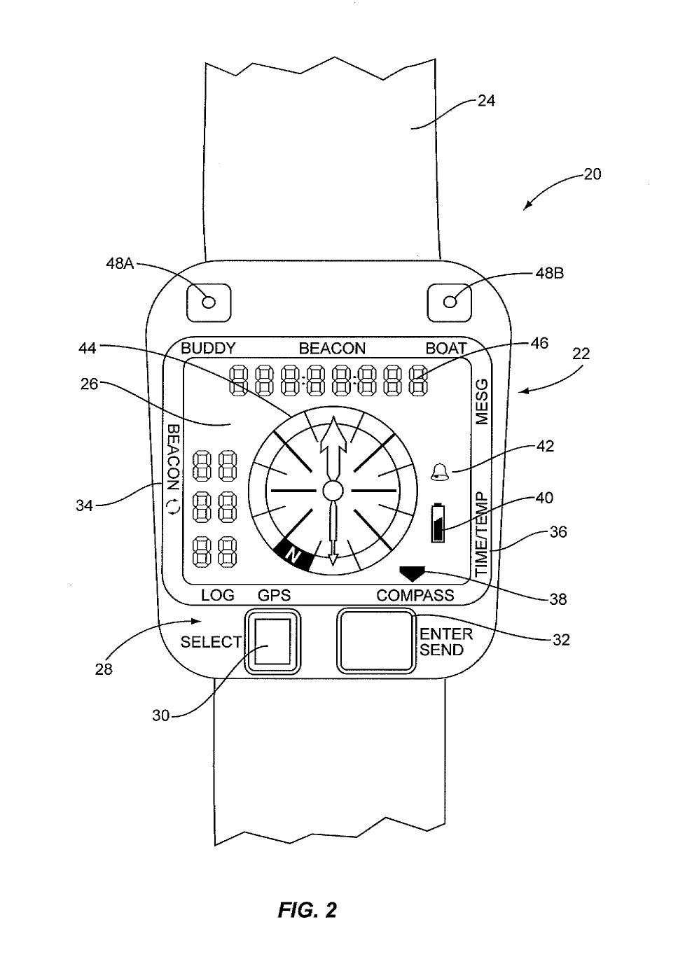

FIG. 2 illustrates an exemplary diver unit 20. The diver unit 20 comprises a waterproof housing 22 mounted on a wristband 24. The diver unit 20 includes an electronic display 26, such as a liquid crystal display, and one or more user input devices 28. The exemplary embodiment shown in FIG. 2 illustrate the user devices 28 as including a scroll wheel 30 and SEND/ENTER button 32. Those skilled in the art, however, will recognize that other user input devices, such as a joystick controller, keypad or touchpad, could be used for user input. Additionally, the display 26 may comprise a touchscreen display to receive user input.

The border 34 of the display 26 includes a series of labels 36 that describe various functions of the diver unit 20 (e.g., “BUDDY,” “BEACON,” “BOAT,” “MESG,” etc.). A function indicator 38 points to the currently selected function. In FIG. 2, the function indicator 38 indicates that the compass function is selected. Additionally, display 26 may display other status indicators, such as power indicator 40 and alarm indicator 42, to provide the user with status information. The function indicator 38 can be moved to select a function by rotating the scroll wheel 30 and pressing the ENTER/SEND button 32.

The effect of rotating the scroll wheel 30 may be context sensitive. For example, the scroll wheel 30 can be rotated to move the pointer 38 to a desired function. The function may then be selected by pressing the ENTER/SEND button 32. Once a function is selected, rotating the scroll wheel 30 can be used to scroll through menus or options associated with the selected function. For example, if the user selects “BUDDY,” the scroll wheel 30 may be used to scroll through and select a buddy from a list of buddies.

In addition to status indicators, the display 26 is used to output useful information to the diver for viewing. In the exemplary embodiment, the display 26 can display a directional indicator 44. As will be described in more detail below, the directional indicator 44 is used to indicate direction to a target for navigating underwater. The display 26 may also include one or more numeric or alphanumeric display areas 46 to display numeric and alphanumeric data to the diver. Examples of numeric data that can be displayed include the current depth, the distance to a specified target, the current time, and the current latitude and longitude. These examples are not intended to be a comprehensive list of all information that can be displayed, but merely illustrative of the types of information that may be displayed.

In some embodiments, the diver unit 20 may also include contacts 48a, 48b to detect when the diver submerges. When the diver submerges, a small amount of current will flow between contacts 48a, 48b, which indicates that the diver has submerged. In response, a processing circuit disposed within the diver unit 20 may perform predetermined functions. For example, the processing circuit, which is seen in more detail below, may be configured to disable a radio transceiver and enable a sonar transceiver responsive to detecting that the diver has submerged. In addition, the processing circuit may control a pressure-sensitive sensor to periodically detect and/or monitor the diver's depth. Of course, such functions are merely exemplary. The processing circuit may be configured to control other functions of the diver unit 20 in addition to, or in lieu of, those detailed above.

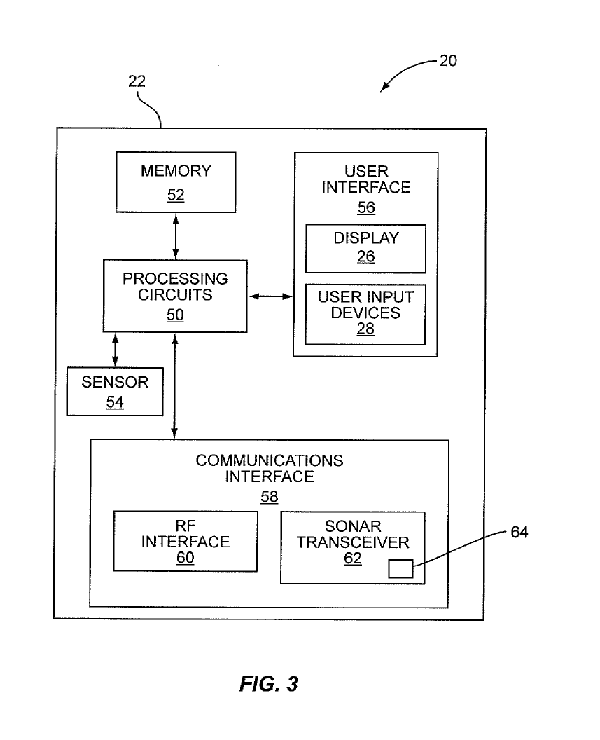

FIG. 3 is a functional block diagram illustrating some of the main components of the diver unit 20. The main components comprise processing circuits 50 for processing data and controlling operation of the diver unit 20, memory 52 for storing code and data used by the processing circuits 50, a pressure-sensitive sensor 54, such as a pressure transducer, for example, to measure the diver's depth, a user interface 56 that includes the previously described display 26 and user input devices 28, and a communications interface 58.

The processing circuits 50 may comprise one or more programmable processors, which may be general purpose microprocessors, microcontrollers, digital signal processors, or a combination thereof. The processor 50 controls the functions of the underwater device 20 according to instructions and data stored in memory 52. According to the present invention, the processor 50 is configured to compute the current location of an underwater diver using only the known locations of two physically distanced beacon units 12, 14. Memory 52 represents the entire hierarchy of memory within the diver unit 10 and may comprise discrete memory devices, or may comprise internal memory in one or more microprocessors. Generally, memory 52 stores the data and instructions used by processor 50 to perform the functions described herein.

The communications interface 58 comprises a radio interface 60 for use above water, and a sonar transceiver 62 for underwater communications. The radio interface 60 may comprise, for example, a conventional BLUETOOTH, 802.11b, or 802.11g interface, or other short-range wireless interface, that allows the underwater device 60 to communicate with a corresponding transceiver above the surface. The sonar transceiver 62 may comprise an array of sonar transducers 64 that receive the underwater signals transmitted by one or more of the submerged beacon units. As described in more detail later, the sonar transducers 64 produce the values used by processor 50 to determine the distance and direction to first and second beacon units 12, 14, as well as the angle of arrival of the signals from the first and second beacon units 12, 14.

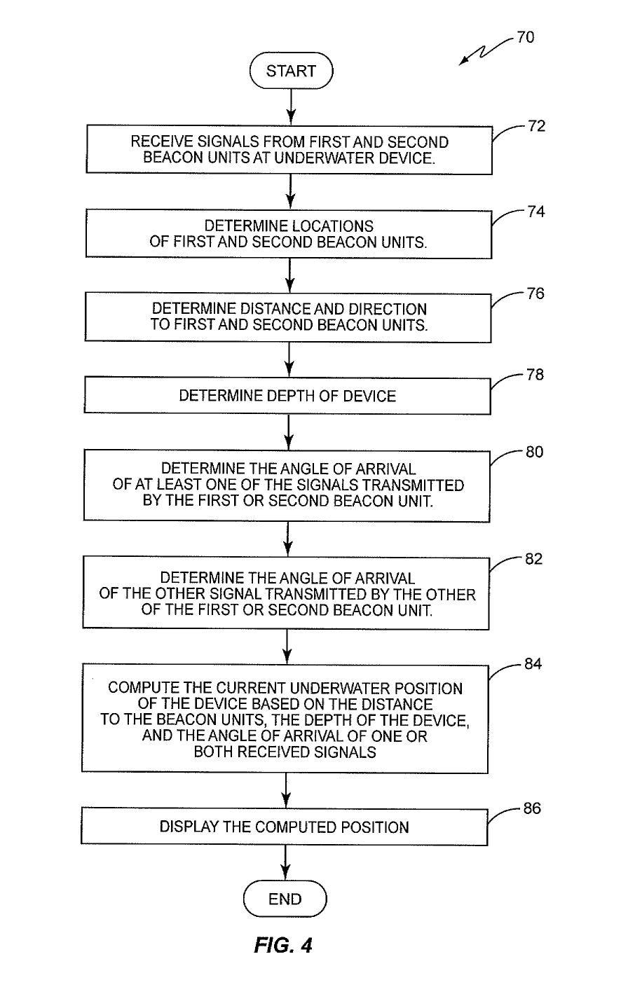

FIG. 4 is a flow diagram illustrating a method 70 performed by the underwater device 20 to compute its position underwater using the known locations of only two beacon units. As previously stated, the method of the present invention deviates from conventional methods that require underwater devices to know the locations of three or more reference points to determine its position.

Method 70 begins with the underwater device 20 receiving signals transmitted by first and second beacon units 12, 14 (box 72). The signals may be, for example, acoustic signals that are received by the sonar transceiver 62 integrated into device 20. The underwater device 20 then determines the location of the first and second beacon units 12, 14 (box 74). Determining the location of the beacon units 12, 14 may be accomplished using any manner known in the art; however, in one embodiment, the beacon units 12, 14 provide their respective locations to the underwater device 20 in a transmitted signal. For example, the beacon units 12, 14 may repeatedly transmit their location information on a frequency known a priori to the underwater device 20, or provide their respective locations to the underwater device 20 responsive to a location request message sent by the underwater device 20. In one embodiment, the underwater device 20 is pre-programmed with the identities and locations of a plurality of beacon units. Signals received from the first and second beacon units 12, 14 could identify them to the underwater device 20, which could then use those identities to determine where the beacon units are located. Regardless of how the underwater device determines the beacon unit locations, however, processing circuit 50 can compute the distance and direction to the first and second beacon units 12, 14 based on the respective received signals from the first and second beacon units 12, 14 (box 76).

The processing circuit 50 then controls the pressure sensor 54 to measure the current depth of the underwater device 20 (box 78), and determines the angle of arrival of at least one of the signals transmitted by one of the first and second beacon units 12 or 14 (box 80). Although device 20 needs only to determine the angle of arrival of one of the received signals, the processing circuit 50 may, in some embodiments, calculate the angles of arrival for both signals transmitted separately by the first and second beacon units 12, 14 (box 82). Once gathered, the processing circuit 50 can compute the position of the underwater device 20 based on the distance and direction to the beacon units 12, 14, the depth of the underwater device 20, and the measured angle of arrival of one or both of the received signals (box 84). The processing circuit 50 may then display the computed position to the user on display 26 (box 86).

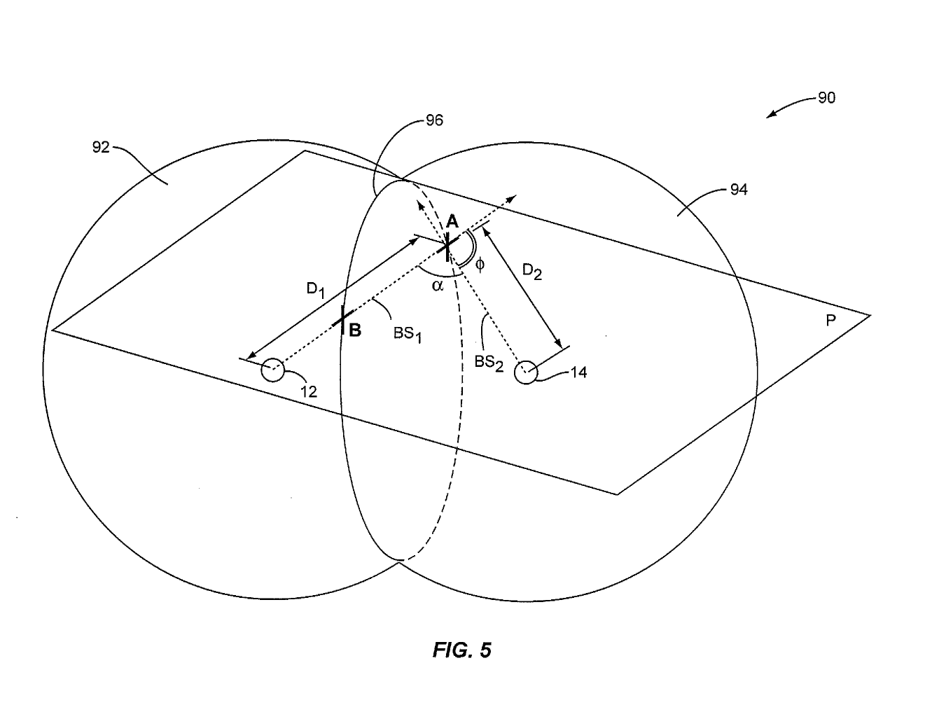

FIG. 5 illustrates graphically the method 70 that is used to compute the 3-dimensional position A of the underwater device 20. As seen in FIG. 5, the two beacon units 12, 14 transmit their signals in omni-directional patterns. Spheres 92 and 94, respectively, represent the radiated pattern of the transmitted signals at a given time t. The beacon units 12, 14 are at the centers of their respective spheres 92, 94. Finding the distances D₁, D₂ to each of the beacon units 12, 14 places the underwater device 20 at a position on a circle 96, which represents the intersection of the two spheres 92, 94. The plane P represents the depth of the underwater device 20, which as stated above may be obtained using sensor 54.

The intersection of the plane P with the intersection of the two spheres 92, 94 (i.e., circle 96) locates the position of the underwater device 20 to be one of only two places A or B on circle 96. By computing the angle of arrival a of the signals transmitted from at least one of the beacon units (e.g., beacon unit 12), the processor 50 can further discriminate between the two possible points A and B to locate the position of the underwater device 20 at position A. In some embodiments, the processor 50 may also compute the angle of arrival φ of the signals transmitted from the other of the beacon units (e.g., beacon unit 14). This could allow the underwater device 20 to locate its position with a higher degree of accuracy.

Various techniques may be used for determining the values necessary to compute an underwater position according to the present invention. For example, any number of techniques may be used to determine the distance between the underwater device 20 and one or both of the beacon units 12, 14. Three exemplary methods for determining distance are described below. These three methods are referred to herein as the time of arrival method, the time of travel method, and the dual tone method. Those skilled in the art will appreciate that the present invention is not limited to the methods enumerated herein and that other methods may be used for determining distance.

The time of arrival method requires clock synchronization between the underwater device 20 and the beacon units 12, 14. In this method, the underwater device 20 sends messages to the beacon units 12, 14 requesting that they transmit a response message at a time known to the underwater device 20. The request or response message may specify the transmit time, or the transmit time may be specified by a protocol. For example, the protocol may specify that the beacon units 12, 14 transmit a response message only when the m least significant bits of the beacon unit's 12, 14 clock are all 0. Because the clocks are synchronized, the underwater device 20 knows the time that the beacon units 12, 14 transmitted the signals, and thus, can use the time of arrival of the signals to compute the distance to each of the beacon units 12, 14.

The time of travel method does not require clock synchronization. In this method, the underwater device 20 sends a message to one or both of the beacon units 12, 14. Upon receipt of the message by the beacon units 12, 14, the beacon units 12, 14 generate and send a reply message to the underwater device 20. The reply message includes a delay value indicating the delay between the time the first message was received at the beacon unit 12, 14 and the time that the reply message was sent back to the underwater device 20. The underwater device 20 may then use the round trip times and the turnaround delays to compute the distances to the beacon units 12, 14.

The dual tone method uses the fact that acoustic signals transmitted at different frequencies will travel at different speeds through water. In this method, the underwater device 20 sends a message to the beacon units 12, 14 requesting the beacon units 12, 14 to send a dual tone signal. In response, each beacon unit 12, 14 transmits a dual tone signal comprising two distinct tones with equal power. The power in each tone will attenuate as a known function of the distance traveled. With knowledge of the attenuation rate for each tone component, the underwater device 20 can compute distance to the beacon unit 12, 14 based on the difference in the received power of the tone components.

Those skilled in the art will appreciate that the operations of the underwater device 20 and the beacon units 12, 14 in the distance calculation could be reversed. That is, the beacon units 12, 14 could compute the distance to the underwater device 20 and transmit the distance to the underwater device 20.

To determine the direction to the target and the angle of arrival of the signal from one or both of the beacon units 12, 14, the sonar transceiver 62 for the underwater device 20 comprises an array of sonar transducers 64. Assuming that the rate of travel of a signal in water is known, the underwater device 20 can compute the direction to the beacon units 12, 14 based on the time difference of arrival of a signal transmitted by the beacon units 12, 14 at each of the sonar transducers 64. The underwater device 20 can also use known mathematical techniques to calculate the angle of arrival of the signals at the sonar transducers 64.

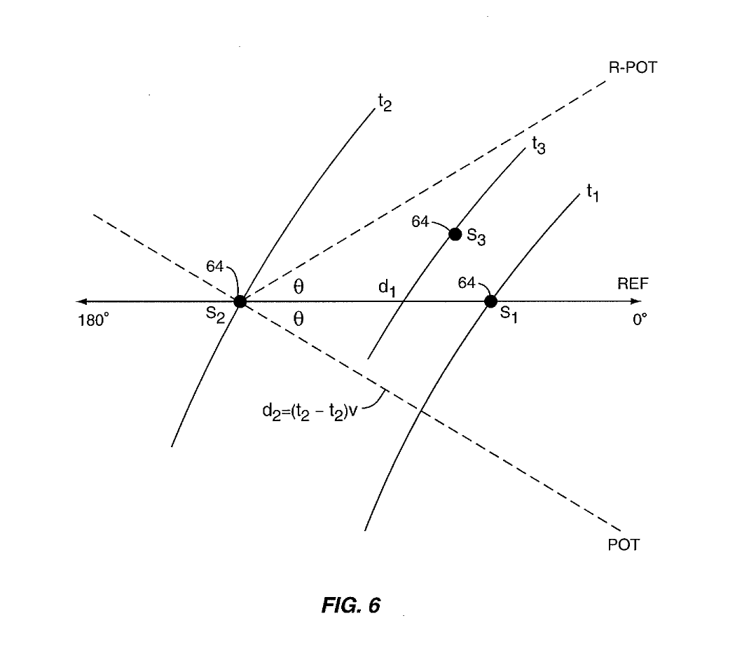

For example, FIG. 6 graphically illustrates how the processor 50 computes the angle of arrival of a signal transmitted from a beacon unit. First and second sonar transducers 64 denoted as S1 and S2, respectively. The line extending through sensors S1 and S2, denoted as REF, serves as an angular reference for directions. The signal from the target beacon unit reaches sensor S1 at time t₁, and reaches sensor S2 at time t₂. The distance d₁ between sensors S1 and S2 along the reference line REF is known. Distance d₂ along the path of travel (POT) of the signal may be computed based on the arrival times of the signal at sensors S1 and S2 by multiplying the difference in arrival time by the velocity v of the signal. The inverse cosine of the ratio d₂/d₁ yields the angle between the reference line REF and the path of travel (POT), and thus, provides the angle of arrival that is used to calculate the underwater position of the device 20.

To unambiguously indicate the direction in two dimensions, a third sensor S3 is required to discriminate between the actual path of travel (POT) and a reflection of the path of travel (R-POT) about the reference line (REF). Those skilled in the art will appreciate that a signal traveling along a line corresponding to the reflected path of travel (R-POT) will produce the same time difference of arrival at sensors S1 and S2. A third sensor S3 enables the processor 50 to discriminate between the actual path of travel (POT) and its reflection (R-POT). The sensor S3 is offset from the reference line REF extending through sensors S1 and S2. To determine direction in three dimensions, at least four sonar transducers 64 are needed, one of which must be outside the plane containing the other three.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of determining the underwater location of a device comprising:
receiving, at an underwater device, first and second signals from first and second beacon units, respectively;
determining, at the underwater device, a first distance to the first beacon unit and a second distance to the second beacon unit;
determining a depth of the underwater device;
determining an angle of arrival of a selected one of the first and second signals at the underwater device; and
computing, at the underwater device, a current location of the underwater device based on the first and second distances, the depth of the underwater device, and the angle of arrival of the selected signal.

2. The method of claim 1 wherein determining the first and second distances at the underwater device comprises:
computing, at the underwater device, a first direction to the first beacon unit and a second direction to the second beacon unit;
computing the first distance at the underwater device based on a time of arrival of the first signal transmitted from the first beacon unit; and
computing the second distance at the underwater device based on a time of arrival of the second signal transmitted from the second beacon unit.

3. The method of claim 2 further comprising determining a location for each of the first and second beacon units based on the first and second received signals.

4. The method of claim 1 further comprising:
extrapolating, at the underwater device, a first sphere having the first beacon unit as a center;
extrapolating, at the underwater device, a second sphere having the second beacon unit as a center, and such that the second sphere intersects the first sphere; and
determining the location of the underwater device to be at the intersection of the first and second spheres.

5. The method of claim 4 wherein the first distance defines a radius of the first sphere and the second distance defines a radius of the second sphere.

6. The method of claim 4 wherein the intersection of the first and second spheres forms a circle on which the underwater device is located.

7. The method of claim 4 further comprising:
establishing a reference plane P defined by the depth of the underwater device; and
determining the underwater device to be located at the intersection of the plane P with the intersection of the first and second spheres.

8. The method of claim 1 wherein determining an angle of arrival of a selected one of the first and second signals at the underwater device comprises:
determining locations for the first and second beacon units;
establishing a first reference line extending between the underwater device and the first beacon unit;
establishing a second reference line extending between the underwater device and the second beacon unit; and
calculating a first angle of arrival θ relative to the first and second reference lines.

9. The method of claim 8 further comprising calculating a second angle of arrival φ relative to the first and second reference lines.

10. The method of claim 8 wherein computing, at the underwater device, a current location of the underwater device comprises computing the current location to be at an intersection of the first and second reference lines.

11. An underwater device comprising:
a receiver to receive first and second signals from first and second beacon units, respectively;
a pressure sensor to determine a depth of the underwater device; and
a processing circuit configured to:
compute a first distance to the first beacon unit and a second distance to the second beacon unit;
calculate an angle of arrival of a selected one of the first and second signals at the underwater device; and
compute a current location of the underwater device based on an intersection of the first and second distances, the depth of the underwater device, and the angle of arrival of the selected signal.

12. The device of claim 11 wherein the processing circuit is configured to:
compute a first direction to the first beacon unit and a second direction to the second beacon unit;
compute the first distance based on a time of arrival of the first signal transmitted by the first beacon unit; and
compute the second distance based on a time of arrival of the second signal transmitted from the second beacon unit.

13. The device of claim 12 wherein the processing circuit is configured to determine a location for each of the first and second beacon units based on the first and second received signals.

14. The device of claim 11 wherein the processing circuit is configured to:
extrapolate a first sphere having the first beacon unit as a center;
extrapolate a second sphere having the second beacon unit as a center, and such that the second sphere intersects the first sphere; and
determine the location of the underwater device to be at the intersection of the first and second spheres.

15. The device of claim 14 wherein the first distance defines a radius of the first sphere and the second distance defines a radius of the second sphere.

16. The device of claim 14 wherein the intersection of the first and second spheres forms a circle on which the underwater device is located.

17. The device of claim 14 wherein the processing circuit is configured to:
establish a reference plane P defined by the depth of the underwater device; and
determine the underwater device to be located at the intersection of the plane P with the intersection of the first and second spheres.

18. The device of claim 11 wherein the processing circuit is configured to:
determine locations for the first and second beacon units;
establish a first reference line extending between the underwater device and the first beacon unit;
establish a second reference line extending between the underwater device and the second beacon unit; and
calculate a first angle of arrival θ relative to the first and second reference lines.

19. The device of claim 18 wherein the processing circuit is configured to calculate a second angle of arrival φ relative to the first and second reference lines.

20. The device of claim 18 wherein the processing circuit is configured to compute the current location of the underwater device to be at the intersection of the first and second reference lines.
